(19) United States
(12) Patent Application Publication
(10) Pub. No.: US 2018/0218319 A1
(43) Pub. Date: Aug. 2, 2018

(54) Systems, Devices, and Methods for Label-Free Shipping

(71) Applicant: Wal-Mart Stores, Inc., Bentonville, AR (US)

(72) Inventor: Robert Cantrell, Herdon, VA (US)

(21) Appl. No.: 15/877,073

(22) Filed: Jan. 22, 2018

Related U.S. Application Data
(60) Provisional application No. 62/453,382, filed on Feb. 1, 2017.

(51) Int. Cl. G06Q 10/08; G06Q 50/28

(52) U.S. Cl. CPC G06Q 10/0833; G06Q 50/28; G06Q 10/087; G06Q 10/0832

(57) ABSTRACT

Methodologies, systems, and computer-readable media are provided for associating delivery information with a remotely located package. Information associated with the package on a machine readable tag is received by an electronic tag-reading device in response to the electronic tag-reading device scanning the machine-readable tag. A computing system remotely located from the machine-readable tag remotely assigns and transmits a first set of delivery information to the machine-readable tag. The computing system also retrieves the current location of the package from one or more databases, and remotely assigns and transmits a second set of delivery information to the machine-readable tag. The second set of delivery information on the machine readable tag is received by the electronic tag-reading device after being scanned by the electronic tag-reading device.

### CROSS-REFERENCED APPLICATIONS

This application claims priority to U.S. Provisional Patent Application Ser. No. 62/453,382, entitled “SYSTEMS, DEVICES, AND METHODS FOR LABEL-FREE SHIPPING,” filed on Feb. 1, 2017, which is hereby incorporated by reference in its entirety.

### BACKGROUND

Various types of products can be labeled and shipped across the world. Packaging and shipping these products sometimes involves the use of printed shipping labels.

### SUMMARY

Embodiments of the present invention utilize a machine-readable tag to associate delivery information, such as a delivery address, with a package associated with the machine-readable tag. For example, delivery information can be assigned and transmitted to the machine-readable tag, and in some embodiments the delivery information can be updated while the package is in transit. Original delivery information or the updated delivery information on the machine readable tag is received by an electronic tag-reading device when the device scans the machine-readable tag. Once the electronic tag-reading device scans the machine-readable tag, the electronic tag-reading device can display the delivery information to a user.

In one embodiment, a system for associating delivery information with a remotely located package includes a machine-readable tag associated with the package and encoded with a unique identifier that identifies contents of the package. Information on the machine readable tag is received by a first electronic tag-reading device in response to the first electronic tag-reading device scanning the machine-readable tag. The system also includes one or more databases holding information regarding the contents of the package, including a current location of the package. The system also includes a computing system in communication with the electronic tag-reading device and the one or more databases. The computing system is remotely located from the machine-readable tag and configured to execute a delivery information module to remotely assign and transmit a first set of delivery information to the machine-readable tag. The delivery information module is also configured to retrieve the current location of the package from the one or more databases, and remotely assign and transmit a second set of delivery information to the machine-readable tag subsequent to the assignment and transmittal of the first set of delivery information such that the second set of delivery information is received by the first electronic tag-reading device or a second electronic tag-reading device in response to the machine-readable tag being scanned by the first or second electronic tag-reading device. The contents of the package are then delivered to an address indicated by the second set of delivery information.

In another embodiment, a method for associating delivery information with a remotely located package includes remotely assigning and transmitting a first set of delivery information to a machine-readable tag associated with the package and encoded with a unique identifier that identifies contents of the package. The method also includes retrieving a current location of the package from one or more databases, and remotely assigning and transmitting a second set of delivery information to the machine-readable tag subsequent to the assignment and transmittal of the first set of delivery information. The second set of delivery information on the machine readable tag is received by an electronic tag-reading device in response to the machine-readable tag being scanned by the electronic tag-reading device. The contents of the package are then delivered to an address indicated by the second set of delivery information.

In another embodiment, a system for associating delivery information with a remotely located package includes a machine-readable tag associated with a package and encoded with a unique identifier that identifies contents of the package. Information on the machine readable tag is received by a first electronic tag-reading device in response to the electronic tag-reading device scanning the machine-readable tag. The system also includes one or more databases holding information regarding the contents of the package, including a current location of the package. The system also includes a computing system in communication with the electronic tag-reading device and the one or more databases, the computing system remotely located from the machine-readable tag and configured to retrieve a current location of the package from one or more databases in response to the machine-readable tag being scanned after the package has begun a transit route. The computing system is also configured to remotely assign and transmit delivery information to the machine-readable tag. The delivery information on the machine readable tag is received by the first electronic tag-reading device or a second electronic tag reading device in response to the machine-readable tag being scanned by the electronic tag-reading device, and the contents of the package are then delivered to an address indicated by the delivery information.

In another embodiment, a method for associating delivery information with a remotely located package includes retrieving a current location of the remotely located package from one or more databases in response to a machine-readable tag associated with the remotely located package and encoded with a unique identifier that identifies contents of the remotely located package being scanned after the package has begun a transit route. The method also includes remotely assigning and transmitting delivery information to the machine-readable tag. The delivery information on the machine readable tag is received by an electronic tag-reading device in response to the machine-readable tag being scanned by the electronic tag-reading device, and the contents of the package are then delivered to an address indicated by the delivery information.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for associating delivery information with a remotely located package, according to an exemplary embodiment.

FIG. 2 is a flowchart illustrating another exemplary method for associating delivery information with a remotely located package, according to an exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for associating delivery information with a remotely located package. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

Conventional shipping labels may contain, for example, computer-readable or human readable information, such as numbers, text, two-dimensional barcodes, three-dimensional barcodes, etc. Such labels, however, require direct line-of-sight to the label and demand space on the exterior of the package and ink for printing. For example, a package beneath another package cannot be read by a human or a traditional barcode reader. Further, updating such labels requires either a removal and replacement of the old label or the insertion of a new label overlapping the old label.

Methodologies, systems, apparatus, and non-transitory computer-readable media are described herein to facilitate associating delivery information with a remotely located package. In exemplary embodiments, a system for associating delivery information with a remotely located package includes a machine-readable tag associated with the package and encoded with a unique identifier that identifies contents of the package. The information on the machine readable tag is received by an electronic tag-reading device in response to the electronic tag-reading device scanning the machine-readable tag. The system also includes one or more databases holding information regarding the contents of the package, including a current location of the package and a computing system in communication with the electronic tag-reading device and the one or more databases. The computing system is remotely located from the machine-readable tag and configured to execute a delivery information module to remotely assign and transmit a first set of delivery information to the machine-readable tag. The delivery information module is also configured to retrieve the current location of the package from the one or more databases, and remotely assign and transmit a second set of delivery information to the machine-readable tag subsequent to the assignment and transmittal of the first set of delivery information so that the second set of delivery information on the machine readable tag is received by the electronic tag-reading device in response to the machine-readable tag being scanned by the electronic tag-reading device. The contents of the package may then be delivered to an address indicated by the second set of delivery information.

In exemplary embodiments, the delivery information associated with the machine-readable tag can include a regional address or a street address. The delivery information can also include additional information, such as a building name or number, an office name, a floor number, or a desk location. Other types of delivery information can include, for example, packing lists, regulatory data, customs data, returns information, security information, delivery instructions, etc. For example, delivery instructions can include instructions to remove some of the contents of a package at a specific location and leave the remainder for delivery elsewhere.

In exemplary embodiments, the techniques described herein can help limit the number of distribution centers needed for packages by eliminating the need to physically address packages between their place of origin and their delivery location. These techniques can also save time by not requiring a mailing label to be written, printed, or secured to a package. Both automated and manual labeling systems use significant materials and time to produce and secure labels on packages, and the physical labels and ink can be costly.

In exemplary embodiments, a package associated with a machine-readable tag can be shipped without a printed address and an address can be assigned to the machine-readable tag after shipment. In some embodiments, a package can be routed or rerouted while in transit, allowing packages to be prepositioned for an anticipated order. In one such embodiment, a shipping truck can act as a mobile distribution center where packages can begin their journey to a particular regional destination and be assigned a local delivery address in transit. Enhanced prepositioning of products becomes easier where forecast models accurately predict the number of products likely to be ordered in a region. For example, a supplier could ship orders from Chicago toward California for expected California orders, and address those packages for specific customers while the packages are on the move as those orders come in. Such a system could be tied to active marketing efforts to sell inbound packages while they are on the way to a given region. The delivery techniques described herein can also allow a user to ship a package to a dynamic location, such as the location of a smartphone or mobile electronic device.

In exemplary embodiments, an electronic tag-reading device can scan the machine-readable tag and show a traditional mailing address using a display screen. In some embodiments, the machine-readable tag can limit which users and devices can scan or read the tag, ensuring that only certain parties, such as a delivery service and a receiver, can view delivery information.

In exemplary embodiments, the class or priority of a package can be updated while in transit, or a package can be recalled after being sent. In other embodiments, packages can be addressed in large groups wherever they are, for example, within a shipping truck, by wirelessly communicating with the machine-readable tags using a communication interface available in the truck. In additional embodiments, a receiver can remotely assign and transmit a delivery address without the sender seeing the actual address, thus increasing privacy.

In one example embodiment, a package can be assigned a delivery address via the Internet or another wireless network using, for example, a mobile application. For example, a mobile electronic device can be in communication with the computing system described above and can remotely provide the delivery address, via a mobile application, that will be assigned and transmitted to the machine-readable tag. In another embodiment, the mobile application can be executed by the electronic tag-reading device.

In exemplary embodiments, the machine-readable tags can be NFC tags, and the NFC tags can be tracked using various electronic devices in communication with the tags enabling a virtual distribution center to understand where the packages are in a distribution stream. An NFC reader, such as a smartphone or other electronic device, can read delivery information assigned to the NFC tag on or in the package and display this delivery information to a user. NFC technology can also provide increased security features, such as a confirming sender identification, confirming receiver identification, activating security features if sender and receiver are not verified, identifying whether a package has been opened or tampered with, and confirming delivery. An NFC tag can also be encoded with payment information and serve as a stamp-free shipping payment system, in some embodiments. In exemplary embodiments, a delivery person can scan an NFC tag using an electronic tag-reading device and the NFC tag can directly input delivery information, such as a delivery address and a suggested delivery route, to the device. In one such embodiment, the electronic tag-reading device can also include geolocation and navigational capabilities and can provide navigation to the desired delivery address.

In alternative embodiments, the machine-readable tag can be an RFID tag associated with the package. The package can also be enabled with both an NFC tag and an RFID tag, wherein the NFC tag includes delivery information and the RFID tag is used to track the geographical location of the package within a shipping container or distribution center. It will be appreciated that one or both types of tags may be used to also store identification information about the package.

In one embodiment, the machine-readable tag can be a fixed marking or label, such as a two-dimensional barcode or three-dimensional barcode. In such an embodiment, a change in the delivery information would take place on a remote computing system, and another electronic or physical means would be used to track the package. For example, an electronic tag-reading device, such as a smartphone, can communicate with the remote computing system and receive the updated delivery information, and can display that delivery information any time it scans the machine-readable tag.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

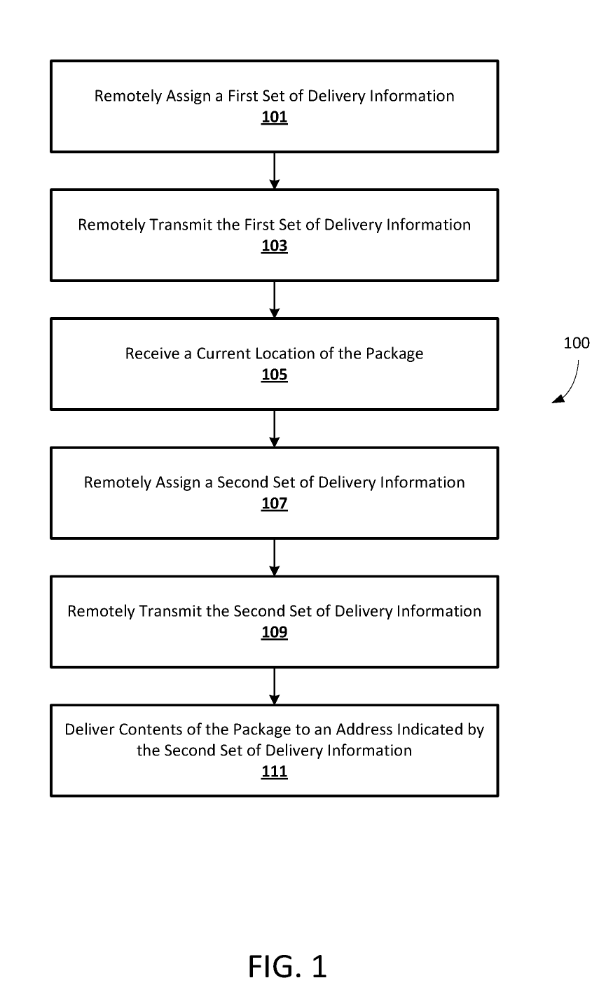

FIG. 1 is a flowchart illustrating an exemplary method 100 for associating delivery information with a remotely located package, according to an exemplary embodiment. It will be appreciated that the method is programmatically performed, at least in part, by one or more computer-executable processes executing on, or in communication with one or more servers described further below. In step 101, a computing device in communication with a first electronic tag-reading device and one or more databases executes a delivery information module to remotely assign a first set of delivery information to a machine-readable tag associated with a package. The information on the machine readable tag is received by an electronic tag-reading device in response to the electronic tag-reading device scanning the machine-readable tag. The computing system can be remotely located from the machine-readable tag, and the machine-readable tag can be encoded with a unique identifier that identifies the contents of the package. Once assigned to the machine-readable tag, the first set of delivery information and its relationship to the machine-readable tag can be stored in a database for later retrieval. The database can also store information regarding the contents of the package, including a current location of the package.

In step 103, the delivery information module remotely transmits the first set of delivery information to the machine-readable tag associated with the package. In exemplary embodiments, the machine-readable tag is an NFC tag or an RFID tag that can store and transmit the first set of delivery information, or other types of delivery information. In one embodiment, the first set of delivery information is transmitted to the first electronic tag-reading device which transmits the first set of delivery information to the machine-readable tag. In another embodiment, the first set of delivery information is transmitted by the delivery information module to a network accessible device in proximity to the machine-readable tag which then forwards the information to the machine-readable tag. For example, a truck may be equipped with network communication capability to communicate with a remote computing system and further equipped to communicate with the machine-readable tag (e.g an RFID reader).

In step 105, the delivery information module retrieves a current location of the package from the database. In some embodiments, the current location of the package can be stored in the database in response to the electronic tag-reading device scanning the machine-readable tag.

In step 107, the delivery information module remotely assigns a second set of delivery information to the machine-readable tag subsequent to assignment and transmittal of the first set of delivery information. In some embodiments, after a first set of delivery information is assigned to the package, such as a first delivery address, the package needs to be re-routed or a more detailed delivery address may need to be assigned. For example, the first set of delivery information may include a regional delivery address and the second set of delivery information may include a local delivery address. This may be helpful when it is known that the package will be shipped to one region of the country, but the local delivery address is not yet available. The package may be assigned a regional delivery address and begin traveling to that region. Once the local delivery address is available, the local delivery address can be assigned to the machine-readable tag, as described herein.

In step 109, the delivery information module remotely transmits the second set of delivery information to the machine-readable tag subsequent to assignment and transmittal of the first set of delivery information. As noted above, several transmittal mechanisms are possible within the scope of the present invention. It should be further appreciated that different electronic tag reading devices may interact with the machine-readable tag at different points in the packages travel. Once the second set of delivery information has been transmitted to the machine-readable tag, the second set of delivery information on the machine readable tag is received by the electronic tag-reading device (the original electronic tag reading device or a different electronic tag reading device). in response to the device scanning the machine-readable tag. In one example, after the first delivery address for the package has been changed, a new delivery address or updated delivery address can be transmitted in the second set of delivery information.

In step 111, the contents of the package are delivered to an address indicated by the second set of delivery information. In exemplary embodiments, the first set of delivery information includes a regional delivery address and the second set of delivery information includes a local delivery address within the regional area of the regional delivery address. In such an embodiment, the package can begin traveling to the regional address once the first set of delivery information is assigned and transmitted to the machine-readable tag, and the contents of the package will be delivered to the local delivery address once the second set of delivery information is assigned and transmitted to the machine-readable tag.

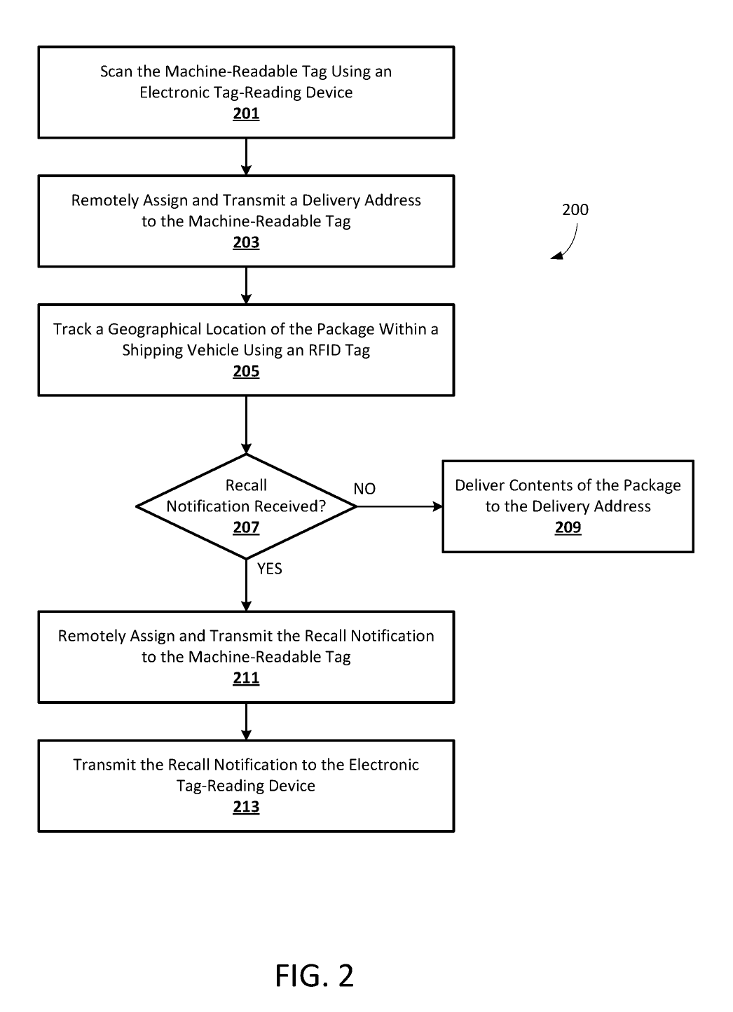

FIG. 2 is a flowchart illustrating another exemplary method 200 for associating delivery information with a remotely located package, according to an exemplary embodiment. It will be appreciated that the method is programmatically performed, at least in part, by one or more computer-executable processes executing on, or in communication with one or more servers described further below. In step 201, an electronic tag-reading device scans a machine-readable tag associated with a package. In exemplary embodiments, the machine-readable tag is an NFC tag or a barcode that can store and/or transmit the first set of delivery information or other information associated with the package.

In step 203, a computing system in communication with the electronic tag-reading device and one or more databases executes a delivery information module to remotely assign and transmit a delivery address to the machine-readable tag associated with the package in response to the electronic tag-reading device scanning the machine-readable tag. The information on the machine-readable tag is received by the electronic tag-reading device in response to the electronic tag-reading device scanning the machine-readable tag. The computing system can be remotely located from the machine-readable tag, and the machine-readable tag can be encoded with a unique identifier that identifies the contents of the package. In exemplary embodiments, the first set of delivery information and its relationship to the machine-readable tag can be stored in a database for later retrieval.

In step 205, an RFID tag associated with the package and distinct from the machine-readable tag scanned in step 201 is used to track the geographical location of the package within a shipping vehicle or shipping container. In some embodiments, the machine-readable tag is an NFC tag or a barcode, and the geographical location of the package within the shipping vehicle or shipping container is tracked using an RFID tag associated with the package. The RFID tag can be scanned using an RFID reader associated with the shipping vehicle or an operator of the shipping vehicle, in some embodiments. In exemplary embodiments, the database can also store information regarding the contents of the package, a current location of the package, and the geographical location of the package within the shipping vehicle.

In step 207, the computing system determines whether a recall notification related to the package has been received. In exemplary embodiments, after the package has been shipped to the delivery address assigned in step 203, the package may need to be recalled and the shipment cancelled. In such an embodiment, a recall notification can be received at the computing system and stored in the database along with the information regarding the contents of the package, the current location of the package, and the geographical location of the package within the shipping vehicle. If there is no recall notification detected in step 207, the method continues to step 209 and the contents of the package are delivered to the delivery address assigned in step 203.

If a recall notification is detected in step 207, the method continues with step 211 and the delivery information module remotely assigns and transmits the recall notification to the machine-readable tag.

In step 213, the recall notification on the machine readable tag is received by the electronic tag-reading device in response to the machine-readable tag being scanned by the electronic tag-reading device. It will be appreciated that the electronic tag-reading device may be different from the electronic tag-reading device that scanned the machine-readable tag earlier in the sequence. In exemplary embodiments, once the recall notification is received by the electronic tag-reading device, the device can visually display the recall notification to a user of the device, or otherwise communicate to the user that the package has been recalled.

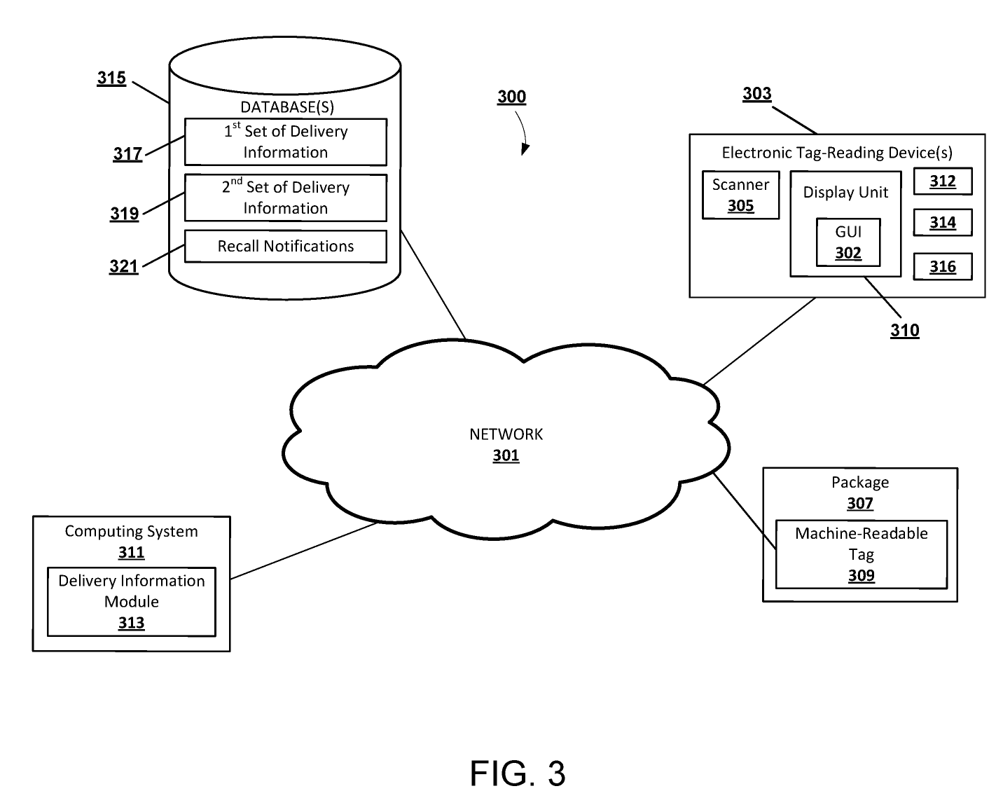

FIG. 3 illustrates a network diagram depicting a system 300 suitable for a distributed implementation of an exemplary embodiment. The system 300 can include a network 301, an electronic tag-reading device 303, a package 307 associated with a machine-readable tag 309, a computing system 311, and a database 315. As will be appreciated, various distributed or centralized configurations may be implemented without departing from the scope of the present invention. In exemplary embodiments, computing system 311 can store and execute a delivery information module 313 which can implement one or more of the processes described herein with reference to FIGS. 1-2, or portions thereof. It will be appreciated that the module functionality may be implemented as a greater number of modules than illustrated and that the same server or computing system could also host multiple modules. The database 315 can store the first set of delivery information 317, the second set of delivery information 319, and the recall notifications 321, as discussed herein. In some embodiments, the delivery information module 313 can communicate with first and second electronic tag-reading devices 303 and the machine-readable tag 309 in order to assign and transmit delivery information and recall notifications, as described herein.

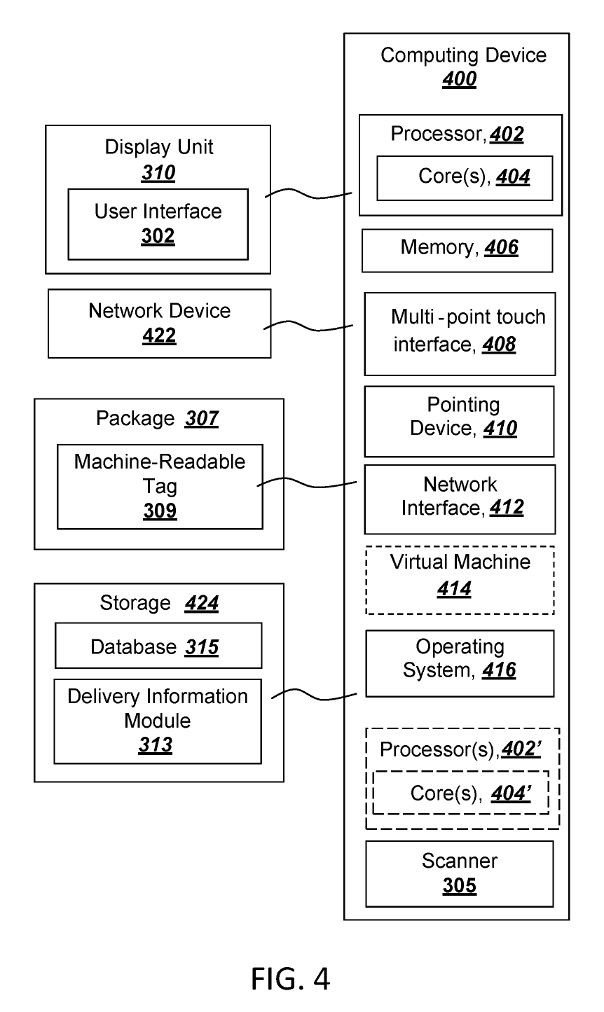

In exemplary embodiments, the electronic tag-reading device 303 may include a display unit 310, which can display a GUI 302 to a user of the electronic tag-reading device 303. The electronic tag-reading device can also include a memory 312, processor 314, and a wireless interface 316, as well as a scanner 305 configured to scan the machine-readable tag 309. In some embodiments, the electronic tag-reading device 303 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, and the like. The electronic tag-reading device 303 may include some or all components described in relation to computing device 400 shown in FIG. 4.

The electronic tag-reading device 303 may connect to a network 301 via a wired or wireless connection. The electronic tag-reading device 303 may include one or more applications such as, but not limited to, a personalized electronic document application, a web browser, a sales transaction application, an object reader application, a geo-location application, and the like. In some embodiments, the machine-readable tag 309 is located at the package 307 and the electronic tag-reading device 303 can interact with the machine-readable tag 309 using the scanner 305.

In exemplary embodiments, the electronic tag-reading device 303, machine-readable tag 309, computing system 311, and database 315 may be in communication with each other via the communication network 301. The communication network 301 may include, but is not limited to, the Internet, an intranet, a LAN (Local Area Network), a WAN (Wide Area Network), a MAN (Metropolitan Area Network), a wireless network, an optical network, and the like. In one embodiment, the electronic tag-reading device 303, machine-readable tag 309, computing system 311, and database 315 can transmit instructions to each other over the communication network 301. In exemplary embodiments, the first set of delivery information 317, the second set of delivery information 319, and the recall notifications 321 can be stored at the database 315 and received at the electronic tag-reading device 303, machine-readable tag 309, and computing system 311 in response to a service performed by a database retrieval application.

FIG. 4 is a block diagram of an exemplary computing device 400 that can be used in the performance of the methods described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 310, such as a touch screen display or computer monitor, which can display one or more user interfaces 302 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 310. The computing device 400 can include other suitable conventional I/O peripherals. The computing device 400 can also include a scanner 305, such as an optical scanner, that can scan and read a machine-readable code, as discussed above.

The computing device 400 can also include one or more storage devices 424, such as a hard-drive, CD-ROM, or other non-transitory computer readable media, for storing data and computer-readable instructions and/or software, such as a delivery information module 313 that can implement exemplary embodiments of the methods and systems as taught herein, or portions thereof. Exemplary storage device 424 can also store one or more databases 315 for storing any suitable information required to implement exemplary embodiments. The databases 315 can be updated by a user or automatically at any suitable time to add, delete, or update one or more items in the databases. Exemplary storage device 424 can store one or more databases 315 for storing the first set of delivery information 317, second set of delivery information 319, recall notifications 321, and any other data/information used to implement exemplary embodiments of the systems and methods described herein.

The computing device 400 can also be in communication with a machine-readable tag 309 associated with a package 307. The computing device 400 can include a scanner 305, such as an optical scanner or an NFC reader, that can scan and read the machine-readable tag 309, as discussed above.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for associating delivery information with a remotely located package, the system comprising:
a machine-readable tag associated with a package and encoded with a unique identifier that identifies contents of the package, wherein information on the machine readable tag is received by a first electronic tag-reading device in response to the first electronic tag-reading device scanning the machine-readable tag;
one or more databases holding information regarding the contents of the package, the information including a current location of the package; and
a computing system in communication with the electronic tag-reading device and the one or more databases, the computing system remotely located from the machine-readable tag and configured to execute a delivery information module to:
remotely assign and transmit a first set of delivery information to the machine-readable tag,
retrieve the current location of the package from the one or more databases, and
remotely assign and transmit a second set of delivery information to the machine-readable tag subsequent to the assignment and transmittal of the first set of delivery information such that the second set of delivery information is received by the first electronic tag-reading device or a second electronic tag-reading device in response to the machine-readable tag being scanned by the first or second electronic tag-reading device,
wherein the contents of the package are delivered to an address indicated by the second set of delivery information.

2. The system of claim 1, wherein the first set of delivery information includes a first delivery address and the second set of delivery information includes a new delivery address.

3. The system of claim 1, wherein the first set of delivery information includes a regional delivery address and the second set of delivery information includes a local delivery address.

4. The system of claim 1, wherein the delivery information module is further configured to remotely assign and transmit a recall notification to the machine-readable tag such that the recall notification is received by the first or second electronic tag-reading device in response to the machine readable tag being scanned by the first or second electronic tag-reading device.

5. The system of claim 1, wherein the machine-readable tag is an NFC tag or RFID tag.

6. The system of claim 1, wherein the machine-readable tag is an NFC tag and wherein the system further includes an RFID tag configured to track a geographical location of the package within a shipping vehicle.

7. The system of claim 1, wherein the delivery information module is further configured to remotely assign a delivery address associated with a current location of the electronic tag-reading device to the machine-readable tag in response to the first or second electronic tag-reading device scanning the machine-readable tag.

8. A method for associating delivery information with a remotely located package, the method comprising:
remotely assigning and transmitting a first set of delivery information to a machine-readable tag associated with a package and encoded with a unique identifier that identifies contents of the package;
retrieving a current location of the package from one or more databases; and
remotely assigning and transmitting a second set of delivery information to the machine-readable tag subsequent to the assignment and transmittal of the first set of delivery information, the second set of delivery information received by an electronic tag-reading device in response to the machine-readable tag being scanned by the electronic tag-reading device;
wherein the contents of the package are delivered to an address indicated by the second set of delivery information.

9. The method of claim 8, wherein the first set of delivery information includes a first delivery address and the second set of delivery information includes a new delivery address.

10. The method of claim 8, wherein the first set of delivery information includes a regional delivery address and the second set of delivery information includes a local delivery address.

11. The method of claim 8, further comprising:
remotely assigning and transmitting a recall notification to the machine-readable tag; and
receiving the recall notification from the machine-readable tag with the electronic tag-reading device in response to the machine-readable tag being scanned by the electronic tag-reading device.

12. The method of claim 8, wherein the machine-readable tag is an NFC tag or RFID tag.

13. The method of claim 8, wherein the machine-readable tag is an NFC tag and the method further includes tracking a geographical location of the package within a shipping vehicle using an RFID tag associated with the package.

14. The method of claim 8, further comprising:
remotely assigning a delivery address associated with a current location of the electronic tag-reading device to the machine-readable tag in response to the electronic tag-reading device scanning the machine-readable tag.

15. A non-transitory machine readable medium storing instructions executable by a processing device, wherein execution of the instructions causes the processing device to implement a method for associating delivery information with a remotely located package, the method comprising:
remotely assigning and transmitting a first set of delivery information to a machine-readable tag associated with a package and encoded with a unique identifier that identifies contents of the package;
retrieving a current location of the package from one or more databases; and
remotely assigning and transmitting a second set of delivery information to the machine-readable tag subsequent to the assignment and transmittal of the first set of delivery information, the second set of delivery information received by an electronic tag-reading device in response to the machine-readable tag being scanned by the electronic tag-reading device;
wherein the contents of the package are delivered to an address indicated by the second set of delivery information.

16. The non-transitory machine readable medium of claim 15, wherein the first set of delivery information includes a first delivery address and the second set of delivery information includes a new delivery address.

17. The non-transitory machine readable medium of claim 15, wherein the first set of delivery information includes a regional delivery address and the second set of delivery information includes a local delivery address.

18. The non-transitory machine readable medium of claim 15, wherein execution of the instructions further causes the processing device to:
remotely assign and transmit a recall notification to the machine-readable tag; and
receiving the recall notification from the machine-readable tag with the electronic tag-reading device in response to the machine-readable tag being scanned by the electronic tag-reading device.

19. The non-transitory machine readable medium of claim 15, wherein the machine-readable tag includes an NFC tag or RFID tag.

20. The non-transitory machine readable medium of claim 15, wherein execution of the instructions further causes the processing device to remotely assign a delivery address associated with a current location of the electronic tag-reading device to the machine-readable tag in response to the electronic tag-reading device scanning the machine-readable tag.

21. A system for associating delivery information with a remotely located package, the system comprising:
a machine-readable tag associated with a package and encoded with a unique identifier that identifies contents of the package, wherein information on the machine readable tag is received by a first electronic tag-reading device in response to the first electronic tag-reading device scanning the machine-readable tag;
one or more databases holding information regarding the contents of the package, the information including a current location of the package; and
a computing system in communication with the electronic tag-reading device and the one or more databases, the computing system remotely located from the machine-readable tag and configured to:
retrieve a current location of the package from one or more databases in response to the machine-readable tag being scanned after the package has begun a transit route, and
remotely assign and transmit delivery information to the machine-readable tag,
wherein the delivery information is received by the first electronic tag-reading device or a second electronic tag-reading device in response to the machine-readable tag being scanned by the first or second electronic tag-reading device, and
wherein the contents of the package are delivered to an address indicated by the delivery information.
